(19) United States
(12) Patent Application Publication
(10) Pub. No.: US 2011/0227947 A1
(43) Pub. Date: Sep. 22, 2011

(54) Multi-Touch User Interface Interaction

(75) Inventors: Hrvoje Benko, Seattle, WA (US); Shahram Izadi, Cambridge (GB); Andrew D. Wilson, Seattle, WA (US); Daniel Rosenfeld, Seattle, WA (US); Ken Hinckley, Redmond, WA (US); Xiang Cao, Cambridge (GB); Nicolas Villar, Cambridge (GB); Stephen Hodges, Cambridge (GB)

(73) Assignee: Microsoft Corporation, Redmond, WA (US)

(21) Appl. No.: 12/725,231

(22) Filed: Mar. 16, 2010

(51) Int. Cl. G09G 5/08; G09G 5/00; G06F 3/041; G06F 3/033

(52) U.S. Cl. 345/650; 345/158; 345/173; 345/163

(57) ABSTRACT

Multi-touch user interface interaction is described. In an embodiment, an object in a user interface (UI) is manipulated by a cursor and a representation of a plurality of digits of a user. At least one parameter, which comprises the cursor location in the UI, is used to determine that multi-touch input is to be provided to the object. Responsive to this, the relative movement of the digits is analyzed and the object manipulated accordingly. In another embodiment, an object in a UI is manipulated by a representation of a plurality of digits of a user. Movement of each digit by the user moves the corresponding representation in the UI, and the movement velocity of the representation is a non-linear function of the digit's velocity. After determining that multi-touch input is to be provided to the object, the relative movement of the representations is analyzed and the object manipulated accordingly.

### BACKGROUND

Multi-touch interaction techniques are becoming increasingly popular for use in direct-touch environments, where the user interacts with a graphical user interface using more than one finger to control and manipulate a computer program. In a direct-touch environment the user's touch directly manipulates the user interface, e.g. through the use of a touch-sensitive display screen.

Multi-touch interaction can be intuitive for users in a direct-touch environment as the users can directly visualize the effect of moving their fingers on the display. However, direct-touch interaction is not common in many computing environments, such as desktop computing. Pointing devices are widely used to support human-computer interaction in these environments. Pointing devices allow the user to move an on-screen cursor using movements of their arm and wrist (e.g. in the case of computer mouse devices) or their fingers and thumb (e.g. in the case of touch-pads and trackballs). Pointing devices can be characterized as providing indirect interaction, as the user interacts with a device to control an on-screen cursor, and the on-screen cursor manipulates objects, buttons or controls in the user interface. Therefore, there is a spatial separation between the device that the user is interacting with, and the display screen.

For indirect interaction, the use of multi-touch is less prevalent. For example, multi-touch enabled touch-pads can be used to provide limited indirect multi-touch input to a user interface, for example to control scrolling. The use of multi-touch for indirect interaction environments is currently limited as the users cannot readily visualize or understand how the multi-touch inputs will be interpreted in the user interface. As a result of this, the adoption of multi-touch input in these environments is low and only a small number of limited multi-touch gestures can be supported without adversely impacting usability.

Furthermore, the sensors used in indirect interaction devices generally only detect a range of movement of the user's fingers that is considerably smaller than the size of the display on which the user interface is displayed. A size disparity such as this does not occur with direct-touch environments, as the user is interacting directly with the display. The relatively small movement range of the indirect interaction device sensors makes it difficult for the user to perform both coarse and fine multi-touch gestures accurately.

The embodiments described below are not limited to implementations which solve any or all of the disadvantages of known indirect human-computer interaction techniques.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Multi-touch user interface interaction is described. In an embodiment, an object in a user interface (UI) is manipulated by a cursor and a representation of a plurality of digits of a user. At least one parameter, which comprises the cursor location in the UI, is used to determine that multi-touch input is to be provided to the object. Responsive to this, the relative movement of the digits is analyzed and the object manipulated accordingly. In another embodiment, an object in a UI is manipulated by a representation of a plurality of digits of a user. Movement of each digit by the user moves the corresponding representation in the UI, and the movement velocity of the representation is a non-linear function of the digit's velocity. After determining that multi-touch input is to be provided to the object, the relative movement of the representations is analyzed and the object manipulated accordingly.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a first example multi-touch mouse device;

FIG. 2 illustrates a second example multi-touch mouse device;

FIG. 3 illustrates multi-touch input from a mouse device and touch-pad;

FIG. 4 illustrates an example multi-touch pointer;

FIG. 5 illustrates a flowchart of a process for controlling multi-touch input to a graphical user interface;

FIG. 6 illustrates movement of a multi-touch pointer in a user interface;

FIG. 7 illustrates input of a multi-touch gesture using a ‘hover cursor’ and ‘click-and-hold’ interaction technique;

FIG. 8 illustrates input of a multi-touch gesture using a ‘click selection’ interaction technique;

FIG. 9 illustrates input of a multi-touch gesture using an ‘independent touches’ interaction technique; and

FIG. 10 illustrates an exemplary computing-based device in which embodiments of the multi-touch interaction techniques can be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a desktop computing-based system, the system described is provided as an example and not a limitation. As those skilled in the art will appreciate, the present examples are suitable for application in a variety of different types of computing systems.

Current indirect interaction techniques are not well suited for the input of multi-touch to traditional ‘window, icon, menu, pointer’ (WIMP) graphical user interfaces (GUI). This is because the users are not able to clearly visualize when multi-touch input can be applied to the user interface, and which objects in the user interface the multi-touch input is applied to. For example, the user may not understand whether multi-touch input is mapped to the region around a cursor, to the user interface as a whole, or independently to some other object or region of interest. In addition, the user may not understand whether the multi-touch input always active, or uses triggering mechanism.

To address this, a technique for multi-touch user interface interaction is provided that allows users consistently understand and visualize how multi-touch input is interpreted in the user interface when using indirect interaction. The user interfaces are controlled using cursors which provide visual feedback to the user on the relative positions of the user's digits (referred to as ‘touch-points’ hereinafter), whilst clearly indicating where in the user interface the multi-touch input is to be applied. Techniques are provided to control when multi-touch input is activated, and which on-screen object it is applied to.

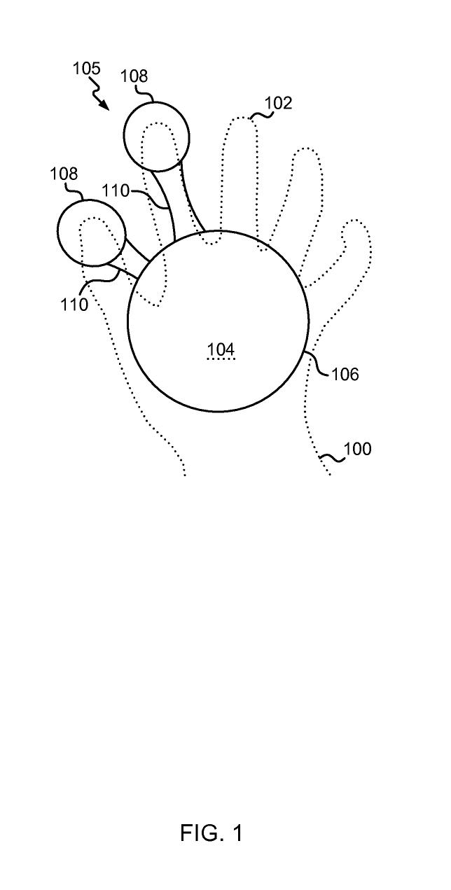

Reference is first made to FIG. 1 to 3, which illustrate examples of different types of indirect interaction devices operable by a user to provide multi-touch input.

FIG. 1 illustrates a schematic diagram of a first example of a multi-touch mouse device. A multi-touch mouse device is a pointing device that has properties in common with a regular mouse device (e.g. it is moved over a surface by the user) but also enables the input of multi-touch gestures.

FIG. 1 shows a hand 100 of a user having digits 102 and a palm 104, underneath which is resting the multi-touch mouse device 105. Note that the term ‘digit’ is intended herein to encompass both fingers and thumbs of the user. The multi-touch mouse device 105 comprises a base portion 106 and a plurality of satellite portions 108. Each of the satellite portions 108 is arranged to be located under a digit 102 of the user's hand 100.

In the example of FIG. 1, the satellite portions 108 are tethered to the base portion 106 by an articulated member 110. In other examples, however, the satellite portions 108 can be tethered using a different type of member, or not tethered to the base portion 106.

The base portion 106 comprises a movement sensor arranged to detect movement of the base portion 106 relative to a supporting surface over which the base portion 106 is moved. Using the movement sensor, the multi-touch mouse device 105 outputs a first data sequence that relates to the movement of the base portion 106. The data sequence can, for example, be in the form of an x and y displacement in the plane of the surface in a given time. In some examples, the movement sensor is an optical sensor, although any suitable sensor for sensing relative motion over a surface can be used (such as ball or wheel-based sensors). The base portion 106 can be arranged to act as a cursor control device, as described hereinafter.

Each of the satellite portions 108 comprises a further movement sensor arranged to detect movement of the associated satellite portion. Using the further movement sensors, the multi-touch mouse device 105 outputs a second data sequence that relates to the movement of each of the satellite portions 108 (i.e. the touch-points) relative to the base portion 106. The further movement sensor in each of the satellite portions 108 can be, for example, an optical sensor, although any suitable sensor for sensing relative motion over a surface can be used (such as ball or wheel-based sensors). Buttons (not shown in FIG. 1) can also be provided on the satellite portions 108 and/or the base portion 106. The buttons provide analogous input to a ‘mouse click’ on a traditional computer mouse device.

The multi-touch mouse device 105 is arranged to communicate the first and second data sequences to a user terminal. For example, the multi-touch mouse device 105 can communicate with the user terminal via a wired connection (such as USB) or via a wireless connection (such a Bluetooth).

In use, the base portion 106 is arranged to be movable over a supporting surface (such as a desk or table top). The satellite portions 108 are also arranged to be movable over the supporting surface, and are independently movable relative to the base portion 106 and each other. In other words, the tethering (if present) between the satellite portions 108 and the base portion 106 is such that these elements can be moved separately, individually, and in differing directions if desired.

The multi-touch mouse device 105 therefore provides to the user terminal data relating to the overall movement of the device as a whole (from the first sequence describing the movement of the base portion 106) and also data relating to the movement of individual digits of the user (from the second data sequence describing the movement of each of the satellite portions 108). The user of the multi-touch mouse device 105 can move the base portion 106 in a similar fashion to a regular mouse device, and also provide multi-touch gestures by moving the satellite portions 108 using their digits.

Note that whilst the example multi-touch mouse device 105 shown in FIG. 1 comprises two satellite portions 108, other examples can have only one satellite portion, or three, four or five satellite portions, as appropriate. Furthermore, in other examples, different types of sensors or multiple motion sensors can be used to enable detection of different types of motion.

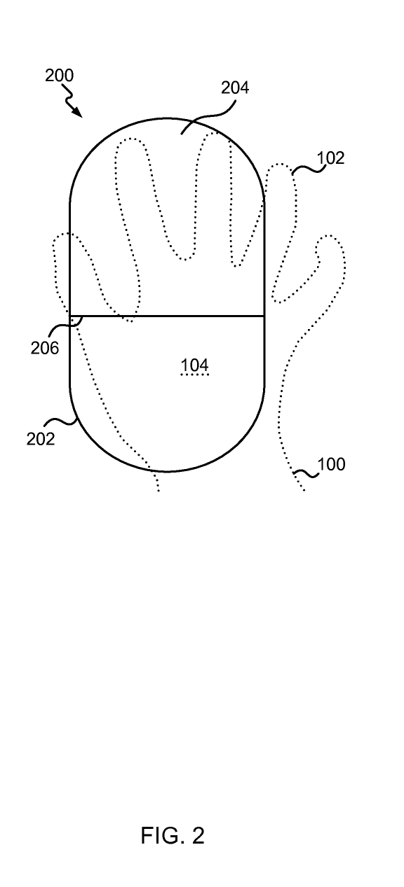

Reference is now made to FIG. 2, which illustrates a schematic diagram of a second example of a multi-touch mouse device 200. FIG. 2 again shows the hand 100 of the user having digits 102 and a palm 104 underneath which is resting the second multi-touch mouse device 200. The multi-touch mouse device 200 comprises a base portion 202 and a touch-sensitive portion 204 overlaid on the base portion 202.

As with the multi-touch mouse device of FIG. 1, the base portion 202 of the multi-touch mouse device 200 of FIG. 2 comprises a movement sensor arranged to detect movement of the base portion 202 relative to a supporting surface over which the base portion 202 is moved. Using the movement sensor, the multi-touch mouse device 200 outputs a first data sequence that relates to the movement of the base portion 202. The first data sequence can, for example, be in the form of an x and y displacement in the plane of the surface in a given time. Preferably, the movement sensor is an optical sensor, although any suitable sensor for sensing relative motion over a surface can be used (such as ball or wheel-based sensors). The base portion 202 can be arranged to act as a cursor control device, as described hereinafter.

The touch-sensitive portion 204 is arranged to sense one or more of the user's digits in contact with the touch-sensitive portion 204 (i.e. the touch-points). The touch-sensitive portion 204 can comprise, for example, a capacitive touch sensor. Using the touch-sensitive portion 204, the multi-touch mouse device 200 outputs a second data sequence that relates to the position and movement of the touch-points on the touch-sensitive portion 204 (and hence relative to the base portion 202) of any of the user's digits in contact with the touch-sensitive portion 204. The extent of the touch-sensitive portion 204 can be shown with a demarcation 206, for example a line, groove or bevel.

The multi-touch mouse device 200 is arranged to communicate the first and second data sequences to the user terminal, e.g. via a wired connection (such as USB) or via a wireless connection (such a Bluetooth). The multi-touch mouse device 200 in FIG. 2 therefore provides to the user terminal data relating to the overall movement of the device as a whole (from the first sequence describing the movement of the base portion 202) and also data relating to the movement of individual digits of the user (from the second data sequence describing the movement of each digit touching the touch-sensitive portion 204). The user of the multi-touch mouse device 200 can move the base portion 202 in a similar fashion to a regular mouse device, and also provide multi-touch gestures by moving their digits on the touch-sensitive portion.

The multi-touch mouse devices shown in FIGS. 1 and 2 are examples only, and other configurations of multi-touch mouse devices can also be used. Different types of multi-touch mouse device are described in U.S. patent application Ser. Nos. 12/485,543, 12/485,593, 12/425,408, and 60/164,830 (MS docket numbers 327366.01, 327365.01, 325744.01, and 327175.01 respectively), incorporated herein by reference in their entirety.

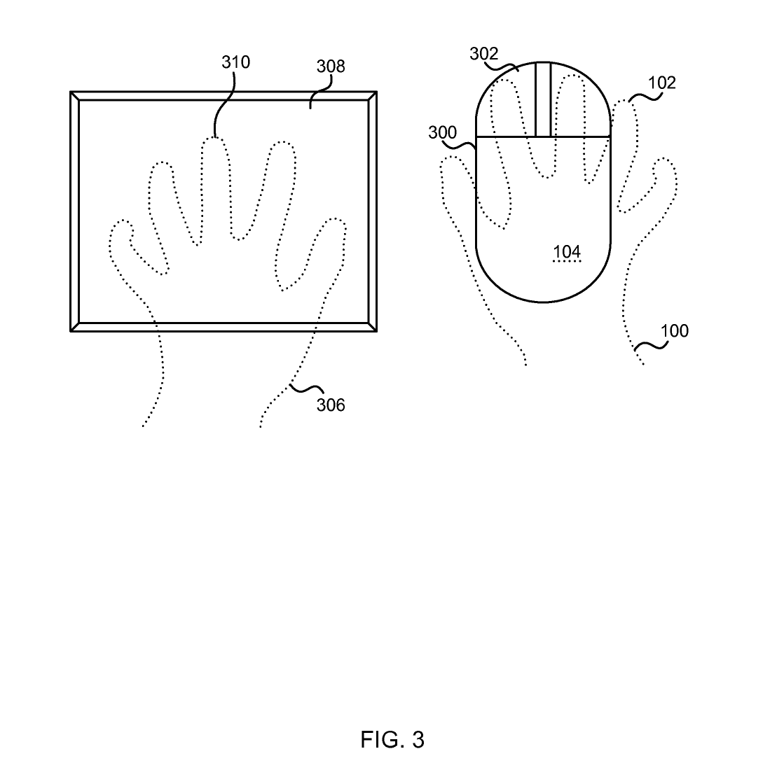

FIG. 3 illustrates an alternative indirect interaction arrangement that does not make use of multi-touch mouse devices. In the example of FIG. 3, the user is using two hands to interact with a user terminal. The first hand 100 of the user is operating a regular mouse device 300, which rests under the palm 104 of the hand 100, and buttons 302 can be activated by the user's digits 102. A second hand 306 of the user is operating a separate touch-pad 308. The touch-pad 308 senses touch-points, i.e. the position and movement of one or more digits 310 in contact with the touch-pad 308.

In the arrangement of FIG. 3, the first hand 100 is used to control the movement of the mouse device 300 over a surface, which is detected and communicated to the user terminal in a first data sequence. The mouse device 300 acts as a cursor control device. The position and movement of the touch-points (the one or more digits 310 in contact with the touch-pad 308) is communicated to the user terminal in a second data sequence.

In one example, the touch-pad 308 can be incorporated into the body of a laptop computer, and the mouse device 300 connected to the laptop computer via a wired or wireless link. In another example, the touch-pad 308 can be a portion of a touch-screen, such as a portion of a surface computing device, and the mouse device 300 can be connected to the surface computing device. In alternative examples, both the mouse device 300 and the touch-pad 308 can be separate from the user terminal. In another alternative example, the mouse device 300 can be replaced with a second touch pad.

Alternative multi-touch capable indirect interaction arrangements or devices can also be used with the techniques described herein. For example, a camera-based technique can use an imaging device that captures images of a user's hand and digits, and uses image processing techniques to recognize and evaluate the user's gestures. In such examples, the overall movement of the user's hand can provide the cursor control (the first data sequence) and the movement of the user's digits can provide the multi-touch input (the second data sequence). The imaging device can be, for example, a video camera or a depth camera.

The one or more indirect interaction devices, such as those described above, are arranged to connect to a user terminal. The user terminal can be in the form of, for example, a desktop, laptop, tablet or surface computer or mobile computing device. The user terminal comprises a least one processor configured to execute an operating system, application software and a user interface. The user interface is displayed on a display device (such as a computer screen) connected to or integral with the user terminal. Input from the indirect interaction devices are used to control the user interface and manipulate on-screen objects.

The key interaction issue with the indirect multi-touch input devices described above is that the user is not generating one but two continuous input data sequences (cursor control and touch-point input), both of which are processed and used to interact with and manipulate on-screen content. In order to integrate such multi-touch inputs in existing cursor-based (i.e. WIMP) user interfaces, four core aspects are considered. The four core aspects are: touch mapping, touch activation, touch focus, and touch feedback. Each of these is described in more detail below. This highlights one of the key tensions in the interaction model: when to defer to a traditional mouse-based cursor model, when to leverage a multi-touch model, or when to create a hybrid of both.

### Touch Mapping

As discussed, with a multi-touch indirect interaction device, the input (from the device) and the output (on the display) are spatially decoupled. Furthermore, such multi-touch indirect interaction devices have a smaller touch-detecting portion than the display output area. This necessitates a decision on how to map the touch-points onto the user interface. The mapping of the touch-points from the multi-touch indirect interaction device onto the user interface can be performed in three ways: display screen, object/region, and cursor mapping.

Display screen mapping transforms the data from the touch-points to the full bounds of the display screen (e.g. touching the top left of the touch-sensitive portion 204 of the multi-touch mouse device in FIG. 2 maps the touch to a location at the top left point of the screen). This mapping can cause a mismatch between input and output size and resolution since a small movement on the sensor can then result in a large movement on the user interface shown on the display.

Object/region mapping bounds the data from the touch-points to a specific on-screen region of the user interface. Such a region can be defined by an on-screen object (e.g. touch-points can be mapped around the center of the object and might be bound by the object bounds). This can also provide an arbitrary mapping depending on the position and size of the object/region.

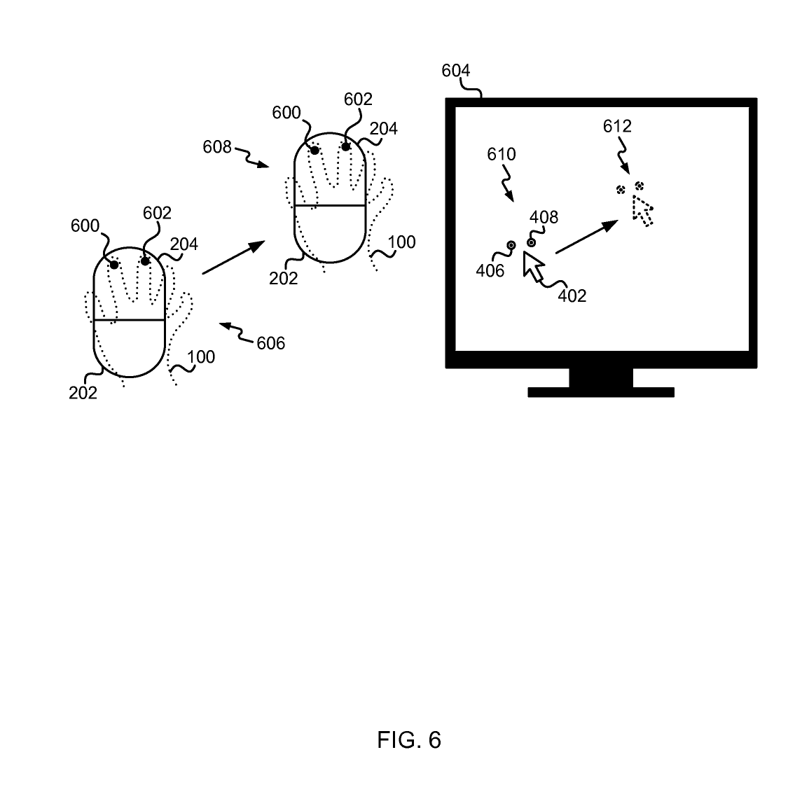

Cursor mapping bounds the data from the touch-points to a predefined or dynamic area centered on the mouse cursor. The position of the touch-points can dynamically change dependent on the position of the cursor. This is described in more detail below with reference to FIG. 6.

Note that each of these mappings can be considered absolute. In other words, when the user touches the center of the touch-detecting portion of a multi-touch indirect interaction device, a touch is registered in the center of the bounds whether those are of the screen, object/region or cursor.

### Touch Activation

The second aspect is the concept of touch activation. This refers to the act that enables the second data sequence from the multi-touch sensor to be active in the user interface. The touch activation can be either implicit or explicit.

The implicit mode has no separate activation and the touch-points are active as soon as they are detected by the multi-touch device. This, in principle, is similar to the default behavior of a direct-touch environment (e.g. a touch screen), which supports only a two-state interaction model (off when not touching, on when touching).

In the explicit mode, touch-points are not active by default, but require a predefined action in order to be activated. Example predefined actions include: mouse actions (e.g. mouse clicks or mouse dwell); touch actions (e.g. taps or touch-point movement); or external actions (e.g. a key press). In some examples, the data relating to the predefined action can be provided to the user terminal as a third data sequence indicating an activation state of a user-operable control. The explicit mode is related to the standard three-state mouse interaction model, which enables the cursor to remain in an inactive hover state until the user is ready to engage by pressing the mouse button. Enabling the hover state means the user can preview where the multi-touch input will occur before committing the input. Explicit activation can also be beneficial for suppressing accidental touches on the multi-touch indirect interaction device. For example, in the case of a multi-touch mouse such as those described above, the mouse is gripped regularly to carry out cursor-based manipulations. As a result, even if it is not the user's intention to trigger a multi-touch input, there can be accidental multi-touch input data that can trigger a false interaction.

### Touch Focus

In addition to mapping the touch-points onto the interface and activating them, there are several options when it comes to choosing the on-screen object(s) to interact with. In a WIMP environment, this is usually referred to as focus, i.e. selecting an object in the interface to receive input exclusively. However, this notion of focus contrasts with the interaction model of direct multi-touch interfaces, where there is no single focus model, and instead multiple objects can be interacted with concurrently with multiple touches. Being a middle ground between a conventional WIMP user interface and a direct multi-touch interface, indirect multi-touch interactions can either have a focus model or not.

If the focus model is not used, each touch-point detected by the indirect interaction device behaves independently and simultaneous actions on multiple on-screen objects are possible. In this way, indirect multi-touch interaction without focus is similar to having the ability to have multi-foci interactions.

However, if the focus model is used, only a single object receives all the multi-touch input. This leads to the decision of how to decide which object in the user interface is in focus. This decision is closely coupled with the activation action, as it is intuitive and efficient to use the same action to both select an object and activate the multi-touch input. Two main selection mechanisms are transient selection and persistent selection.

Transient selection of focus means that the on-screen object maintains its focus only while a selection event is happening. This can be, for example, while the cursor is above the object, while the user is clicking on the object, or while the touch-points are moving over the object.

Persistent selection means that, once selected, the on-screen object remains in focus until some other action deactivates it. The persistent mode is therefore a toggle state in which multi-touch inputs are activated until some other event deactivates them. For example, multi-touch input can be active while the object remains selected, or a mouse click can activate multi-touch input and then another mouse click can deactivate it. Traditional WIMP interfaces primarily use the persistent selection technique for cursor interactions.

### Touch Feedback

The intrinsic inability of indirect interaction devices to directly interact with the interface (in contrast to multi-touch screens or surfaces) means that the user loses the natural visual feedback of the input from their hands touching or hovering above the display. It is therefore beneficial to provide on-screen feedback to mark the location of their touches.

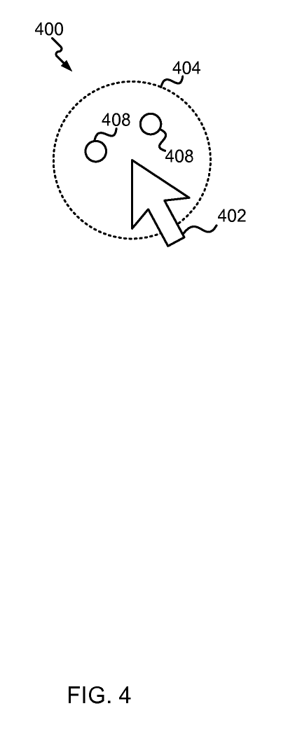

There are three feedback categories available for visualizing or displaying a user's touches: no explicit feedback; individual touch feedback; and aggregate touch feedback. When there is no explicit touch feedback, the user is left to deduce the actions from the resulting manifestation of the objects in the interface (e.g. from the object's movement). Alternatively, with individual touch feedback, a visualization can include each individual touch-point. An example of this is illustrated in FIG. 4 and discussed below. Lastly, feedback can also be presented in an abstract form of an aggregated representation resulting from the touch-points (e.g. the cursor itself can change appearance based on the number and position of the touches). These feedback forms can also be utilized together. Different types of multi-touch input feedback are described in U.S. patent application Ser. No. 12/571,649 (MS docket number 328019.01), incorporated herein by reference in entirety.

As mentioned, FIG. 4 illustrates an example of individual touch feedback. FIG. 4 shows a traditional arrow-shaped cursor augmented with information regarding the position of the digits of the user (the touch-points). A cursor augmented with representations of the user's digits is referred to herein as a ‘multi-touch pointer’. The multi-touch pointer 400 comprises an arrow-shaped cursor 402 rendered in a user interface, and surrounding a control point of the cursor 402 (e.g. the tip of the arrow head) is a touch region 404. Within the touch region 404 is displayed a representation of the relative positions and movement of the digits of the user (as derived from the second data sequence). The multi-touch pointer 400 shows a first representation 406, corresponding to a first digit of the user, and a second representation 408, corresponding to a second digit of the user. The number of digits shown can depend on the number of digits detected (e.g. in the case of touch-sensitive hardware such as in FIG. 2 or 3) or on the capabilities of the hardware used (e.g. the number of satellite portions of the mouse device of FIG. 1).

The combination of the cursor 402 and the touch region 404 showing representations of the touch-points provide user feedback and improve the usability and accuracy of multi-touch inputs. In the example of multi-touch pointer 400, multi-touch input can be visualized by the relative movement of the first representation 406 and the second representation 408. The touch region 404 shown in FIG. 4 is illustrated with a dashed line. In some examples, the boundary of the touch region 404 is not visible to the user in the user interface. However, in other examples, the touch region 404 can be displayed to the user, e.g. by drawing the boundary or shading the interior of the touch region.

Whilst the shape of the touch region 404 shown in FIG. 4 is circular, any suitable shape for the touch region can be used. Similarly, the size of the touch region in FIG. 4 is also merely illustrative, and can be larger or smaller. The size and shape of the touch region 404 can be defined by the touch mapping aspect described above. For example, the touch region 404 can be the size and shape of the screen for display screen mapping, or the size and shape of an on-screen object for object/region mapping. In the case of cursor mapping, the shape of the touch region 404 can, for example, reflect the shape of the hardware used for indirect interaction. For example, if the user's digits are detected on a touch-pad, the shape of the touch-region can reflect the shape of the touch pad.

Furthermore, in other examples, the touch region 404 can be located away from the control-point of the cursor, for example to the side of or above the cursor in the user interface. In further examples, the location of the touch region relative to the cursor can be controlled by the user, as described in more detail hereinafter. For example, the user can choose where in relation to the cursor the touch region is displayed, or choose to temporarily fix the touch region at a given location in the user interface.

Note that the form of the multi-touch pointer 400 is merely illustrative and other forms (e.g. using shapes other than arrows for cursors and circles for touch-points) can also be used.

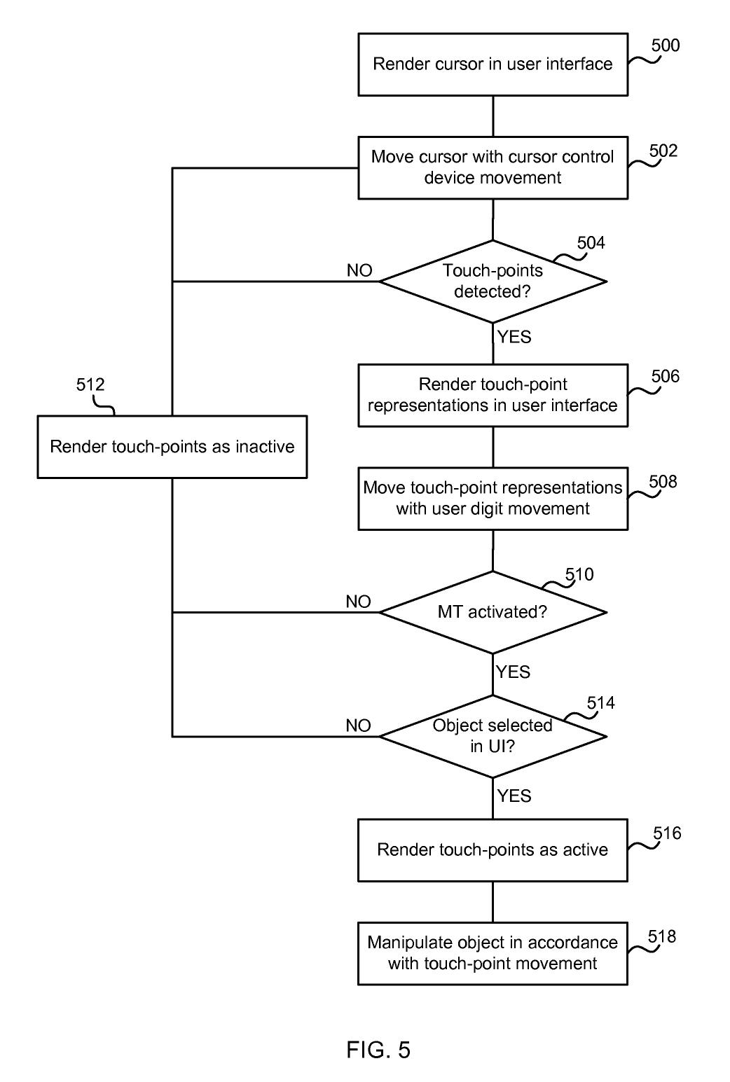

Reference is now made to FIGS. 5 to 9, which illustrate several interaction techniques which utilize the aspects of touch mapping, touch activation, touch focus, and touch feedback described above to enable effective multi-touch input in indirect interaction environments. The techniques described in FIG. 5 to 9 each utilize the individual touch feedback as illustrated in FIG. 4, although other examples can utilize a different cursor feedback. These techniques utilize different combinations of the touch mapping, touch activation and touch focus aspects to enable the multi-touch interaction.

Firstly, reference is made to FIG. 5, which illustrates a flowchart of a process for controlling multi-touch input to a graphical user interface using the above-described aspects. The process of FIG. 5 is performed by the processor at the user terminal with which the indirect multi-touch device is communicating. Firstly, the cursor (e.g. cursor 402 from FIG. 4) is rendered 500 in the user interface by the processor, and displayed on the display device. In the example of FIG. 5, representations of the user's digits are not shown until they are detected by the multi-touch input device, and hence only the cursor 402 is shown at this stage. Note, however, that some multi-touch input devices provide touch-point data at all times (such as the device of FIG. 1).

The display of the cursor 402 is controlled by the processor such that the cursor 402 is moved 502 in the user interface in dependence on the first data sequence, i.e. in accordance with the cursor control device (e.g. base portion 106, 202 or mouse device 300). Therefore, the interaction behavior at this stage is consistent with a traditional WIMP interface.

The processor determines 504 whether touch-points are detected. In other words, it is determined whether the second data sequence indicates that one or more digits of the user are touching the multi-touch input device. If this is not the case, the process returns to moving just the cursor 402 in accordance with the first data sequence in a manner consistent with a traditional WIMP interface.

If, however, one or more digits of the user are touching the multi-touch input device, then touch-points are detected. Responsive to detecting touch-points, the processor renders 506 the representations of the user's digits (e.g. representation 406, 408) in the user interface. The location at which the representations are rendered depends upon the ‘touch mapping’ aspect described above. If object/region mapping is used, but there is no on-screen object to which to map the touch-points, then cursor mapping can be used instead until an object is present to define the mapping bounds.

The display of the touch-point representations is controlled by the processor such that the representations are moved 508 in the user interface in accordance with the second data sequence, i.e. in accordance with movement of the user's digits. The user can therefore visualize how moving their digits is being detected and interpreted.

The processor then determines 510 whether multi-touch input is activated. This is therefore the ‘touch activation’ aspect described above. If the touch activation is in implicit mode, then multi-touch is active as soon as touch-points are detected, and hence the output of this determination is ‘yes’. If the touch activation is in explicit mode, then the determination depends on the evaluation of whether the predefined action has occurred (e.g. a predefined button or key press).

If it is determined that multi-touch is not activated, then the processor renders 512 the representations as inactive. For example, the processor can render the representations grayed-out. This indicates to the user that their touch-points are being detected, but at this stage they cannot be used to enter multi-touch input.

If, however, the processor determines 510 that multi-touch is activated, then the processor determines 514 whether an object in the user interface has been selected to receive the multi-touch input. In other words, this is the ‘touch focus’ aspect described above. Depending on the focus model used, this determination can depend on at least one parameter. If no focus model is used, then the result of this determination is only dependent on whether one or more of the representations are coincident with one or more on-screen objects (which in turn can depend on the location of the cursor in the user interface). In this case, if one or more of the representations are coincident with one or more on-screen objects, then those objects are selected. However, if a focus model is used, then the determination evaluates whether an on-screen object is currently in focus (as a result of either the transient or persistent focus model). In this case, the determination parameters include the location of the cursor in the user interface (e.g. whether or not it is coincident with the object) and, in the case of persistent focus, whether the object has been explicitly selected (e.g. using a mouse click).

If it is determined that there is no object currently selected, then the touch-point representations are rendered as inactive, as described above. If, however, it is determined that an object is selected, then the touch-point representations are rendered 516 as active. For example, the processor can render the representations in a solid white or other color (i.e. not grayed-out). This indicates to the user that they are able to use their digits to enter multi-touch input.

The processor then analyses the movement of the user's digits from the second data sequence, and manipulates 518 the selected on-screen object (or objects) in accordance with the movements. Manipulating the object can comprise, for example, rotating, scaling and translating objects. For example, if the object is an image that the user wishes to rotate, then the user uses two digits to trace two separate arcuate movements on the multi-touch input device. Therefore, the two digits maintain substantially the same separation, but the angle between them changes. The change in angle of the two touch-points is detected as a multi-touch gesture for rotation, and a corresponding rotation is applied to the image. As another example, if the object is an image that the user wishes to rotate, then the user uses two digits to trace two separate movements which maintain substantially the same angle, but the separation between them changes. The change in separation of the two touch-points is detected as a multi-touch gesture for scaling, and a corresponding stretching or resizing of the image is applied.

Reference is now made to FIG. 6, which illustrates the movement of a multi-touch pointer in a user interface in the case where there are no objects to manipulate. This illustrates how the cursor 402 and representations 406, 408 operate when multi-touch is not active. In FIG. 6, the multi-touch mouse device 200 of FIG. 2 is used as an illustrative example. The user is touching the touch sensitive portion 204 with two digits of hand 100, as indicated by dots 600 and 602. The multi-touch pointer comprising cursor 402 and representations 406, 408 is rendered and displayed in a user interface shown on display device 604. The representations 406, 408 are shown grayed-out, as multi-touch is not active due to no objects being present to receive the multi-touch data. Note that, in this example, the cursor mapping scheme is used, and the representations are positioned in proximity to the cursor 402.

In the example of FIG. 6, the base portion 202 is moved by the user from a first position 606 to a second position 608. Note that, in this movement, the position of the user's touches on the touch-sensitive portion 204 do not substantially change. When the multi-touch mouse device is in the first position 606, the multi-touch pointer is also in a first position 610. As the multi-touch mouse is moved to the second position 608, the on-screen multi-touch pointer moves to a second position 612. Note that as the cursor 402 moves across the display, so too do the representations 406 and 408, due to the cursor mapping scheme. In addition, because the user's digits are not moving relative to the base portion 202 during the motion, the representations 406 and 408 do not move substantially relative to the cursor 402 (i.e. their relative locations are maintained). Therefore, the behavior of the multi-touch mouse device and pointer in the example of FIG. 6 is similar to that of a traditional mouse and on-screen cursor, and hence familiar to users.

Four interaction schemes are now described that use the process of FIG. 5 and utilize the aspects of touch mapping, touch activation, touch focus, and touch feedback to provide multi-touch interaction when objects are present on-screen. The four interaction schemes are called ‘hover cursor’, ‘click and hold’, ‘click selection’ and ‘independent touches’, and are described in turn below.

### Hover Cursor

The hover cursor scheme utilizes a combination of implicit touch activation, a transient touch focus model, and cursor mapping. Therefore, in this scheme, multi-touch input is active whenever touch-points are detected. In other words, the activation is implicit as no explicit action is needed to activate the multi-touch (beyond the actual contact with the sensor). An on-screen object to receive the multi-touch input is selected by the location of the cursor in the interface. Only the on-screen object directly under (i.e. coincident with) the cursor responds to all of the touch-points. This object is selected and provided with the multi-touch data regardless of whether the touch-point representations are also located over the object.

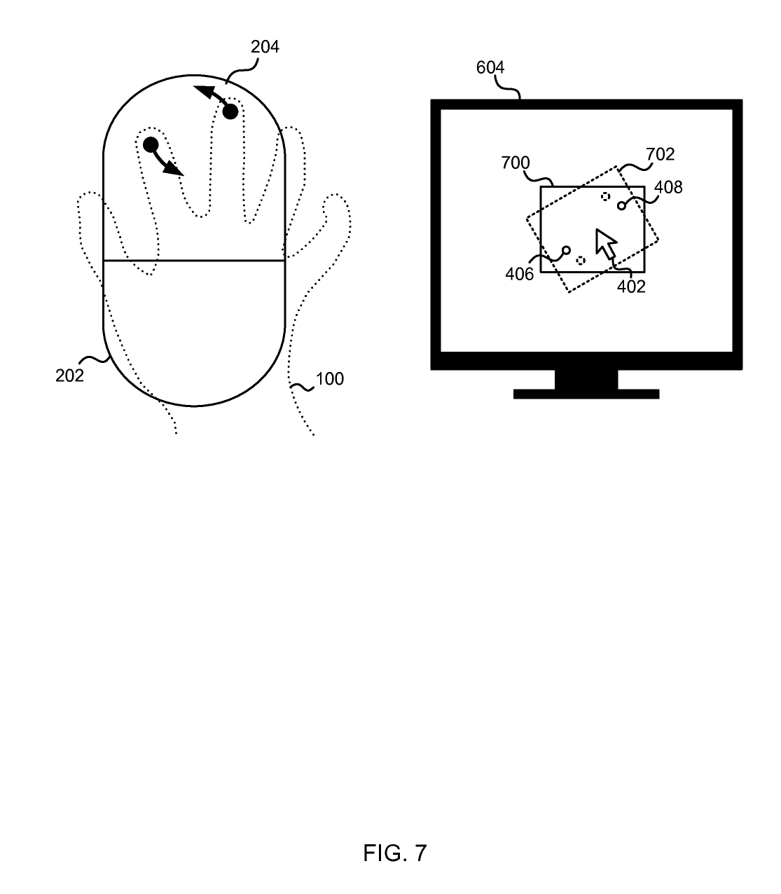

The operation of this scheme is illustrated in more detail in FIG. 7. In this example, the user is using multi-touch to rotate an on-screen object 700 displayed in the user interface shown on the display device 604. The multi-touch mouse device 200 of FIG. 2 is used as an illustrative example. The user is touching the touch-sensitive portion 204, and hence representation 406, 408 are shown in the user interface, and these are located in proximity to the cursor 402 as the cursor mapping scheme is used. This activates the multi-touch input. Because the cursor 402 is located over the object 700, the transient focus model selects the object 700 to receive the multi-touch input. The representations are therefore rendered as active to indicate to the user that multi-touch gestures can be performed. In this example, the user moves the digits on the touch-sensitive portion 204 counter-clockwise to change the angle between them, and the representations move in the user interface accordingly, and the object moves with them to a rotated position 702.

### Click and Hold

The click and hold scheme is similar to the hover cursor scheme, in that it uses the same transient touch focus model and cursor mapping. However, this scheme uses explicit multi-touch activation. In this example, the multi-touch is activated by the actuation of a user-operable control (e.g. mouse button) by the user. The user terminal detects that a user-operable control is held in an activated state whilst the cursor location is coincident with the location of the object in the user interface. In other words, the touch-points are active only while the user is keeping the mouse button pressed, and the touch-points only affect a single object underneath the cursor. Therefore, as with the hover cursor scheme, an on-screen object is selected by the location of the cursor in the interface, and only the on-screen object directly under the cursor responds to the touch-points. This object is selected and provided with the multi-touch data regardless of whether the touch-point representations are also located over the object.

The operation of this scheme can also be illustrated with reference to FIG. 7. However, the difference compared to the hover cursor scheme is that the touch-point representations are only rendered as active, and only enable rotation of the object 700 when a mouse button is pressed. Without actuation of the mouse button, the touch point representations remain inactive, and do not interact with the object 700. The mouse button is not shown FIG. 7, but in one example can be present on the underside of the multi-touch mouse device 200 and activated by the palm 104 of the user. In other examples, the mouse button can be located on a different portion of the mouse device, or alternatively a separate actuation mechanism can be used, such as a key on a keyboard.

### Click Selection

The click selection scheme utilizes a combination of explicit touch activation (like the click and hold scheme), persistent touch focus, and object/region mapping. In this case, the explicit touch activation and persistent focus are combined into a single action, such that, in order to activate multi-touch input for an object, the user selects (e.g. clicks on) an object of interest using a user-operable control (e.g. mouse button) and the object remains in focus until de-selected. This is detected by the user terminal as a change to an activated state of a user-operable control for at least a predefined time interval whilst the cursor location is coincident with the object in the user interface. The touch-points are then mapped using object/region mapping to the selected object and are completely decoupled from the cursor. Prior to an object being selected, the touch-point representations are located in proximity to the cursor in accordance with the cursor mapping scheme.

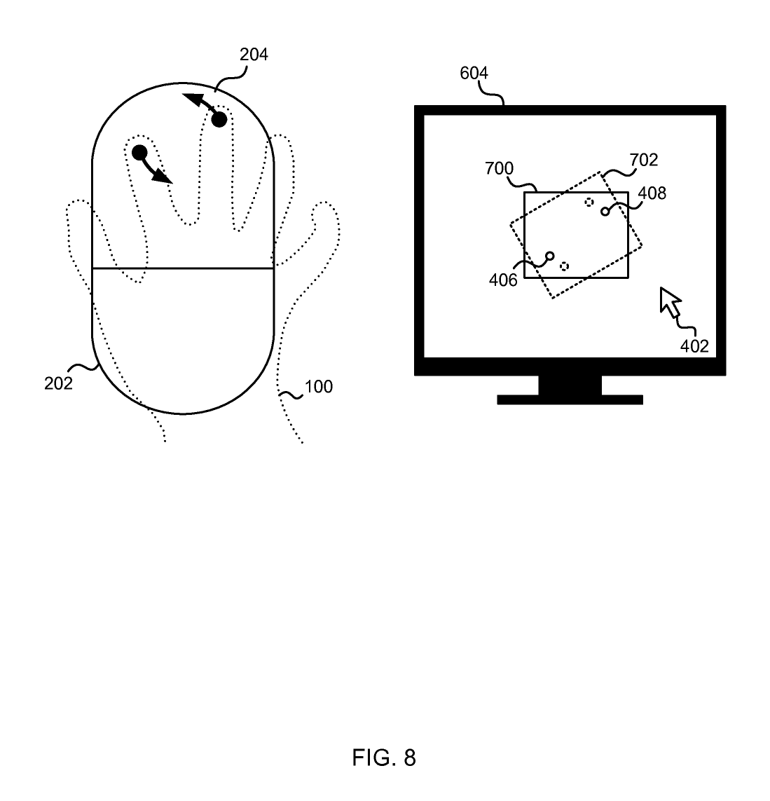

The operation of the click selection scheme is shown illustrated in FIG. 8. Prior to selection of an object, the cursor 402 and touch-point representations 406, 408 can be moved in the user interface together, in a similar manner to that shown in FIG. 6. However, once the cursor 402 is placed over the object 700 and the object is explicitly selected (e.g. with a mouse click) the operation is as shown in FIG. 7. After object selection, the touch mapping becomes object/region mapping, so that the touch-point representations 406, 408 are now bound to the object 700. This means that the cursor 402 can be independently moved away from the representations without affecting the multi-touch input to the object 700. This includes moving the cursor 402 so that it is no longer coincident with the object 700 in the user interface. The object 700 remains selected and continues to receive multi-touch input from the touch-points (and the representations remain bound to the object) until another action (e.g. mouse click) deselects the object. This can occur, for example, by clicking in the user interface background away from the object 700, or selecting a different object.

### Independent Touches

The independent touches scheme utilizes a combination of cursor mapping, implicit activation, and no focus model. Therefore, in the independent touches scheme, there is no notion of a single object in focus. Every object in the user interface responds to touch-point representations that are positioned over them. This therefore enables simultaneous multi-object manipulation. As cursor mapping is used, an on-object can therefore be selected by positioning the cursor such that a touch-point representation is coincident with the object. The object remains selected only while the representation is coincident with the object. The implicit activation mode means that multi-touch input is active as soon as the touch-points are detected, without any additional explicit activation action.

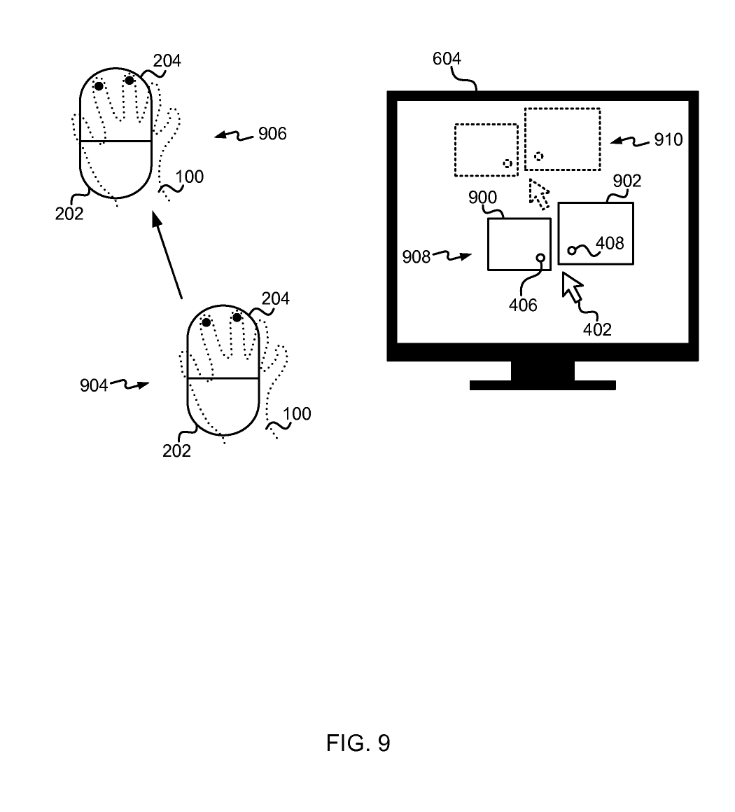

The operation of the independent touches scheme is illustrated in FIG. 9. In this example, a first object 900 and second object 902 are displayed in the user interface. An object is selected and multi-touch activated whenever a touch-point is detected and the representation of the touch-point is coincident with an object. In this example, two touch-points are detected on the touch-sensitive portion 204 of the multi-touch mouse device, resulting in two representations 406, 408. The cursor 402 is located such that representations 406 is positioned coincident with the first object 900, and representations 408 is positioned coincident with the second object 902. Therefore, both of these objects are selected to receive multi-touch input. In this case, the user is performing a translation operation, by moving the base portion of multi-touch mouse device from a first position 904 to a second position 906, and consequently both the first object 900 and second object 902 are translated in the user interface from a first position 908 to a second position 910.

The above-described four schemes provide techniques for multi-touch user interface interaction that enable control of when multi-touch input is activated, and which on-screen object it is applied to. This enables multi-touch input to be provided to traditional WIMP-based user interfaces from indirect interaction devices. The schemes enable the user to understand and visualize how multi-touch input is interpreted in the user interface when using indirect interaction by providing visual feedback to the user on the relative positions of the user's digits, whilst providing certainty on where in the user interface the multi-touch input is to be applied. Note that the above four schemes are not mutually exclusive, and can be used in combination. For example, some applications can be more suited to one of the schemes than another, and hence different schemes can be used in different applications. In addition or alternatively, the user can be provided with the option of selecting which interaction scheme to use.

As mentioned hereinabove, a size discrepancy exists between the range of movement that the user's digits can make on an indirect multi-touch interaction device, and the size of the user interface shown on the display device. Such a discrepancy does not occur in direct-touch environments. As a result of this, a wide range of control between fine and coarse multi-touch gestures is difficult.

For example, when performing a multi-touch scaling gesture, the user may wish to scale an object to the full size of the user interface. However, the user can only move their digits a small distance apart, due to the size constraints of the multi-touch interaction device (e.g. the size of the touch-sensitive portion 204 in FIG. 2). If the movements on the multi-touch input device are magnified such that this gesture is possible (or if display screen mapping is used) then it becomes difficult for the user to perform small manipulations of the on-screen object, as even small digit movements result in large movements of the representations on the user interface.

To address this, the movements of the touch-points representations in the user interface can be controlled using an acceleration (or ballistics) algorithm. With this algorithm, the velocity of movement of a representation is found by a non-linear function of the velocity of the corresponding digit. When an acceleration algorithm is used, the movement velocity of the representation is proportionately larger for a fast movement velocity of a digit than for a smaller movement velocity of a digit. The result of this is that when a digit is moved quickly over the indirect interaction device for a given distance, the representation travels further over the user interface than if the same movement of the digit is performed more slowly.

The result of this is that it enables both coarse and fine multi-touch gestures to be performed despite the limited size of the indirect multi-touch interaction device. For example, if the user wants to perform the large scaling operation described above, then the user moves the digits rapidly over the indirect multi-touch device, which causes the representations to travel a large distance on the user interface, and hence perform a large scaling operation. Conversely, to perform a fine gesture, the user moves the digits slowly over the indirect multi-touch device, which causes the representations to travel a small distance on the user interface, and hence perform a fine-scale operation.

This non-linear function can be applied to the movement of the touch-point representations regardless of the touch-mapping used, i.e. for each cursor, object/region and display screen mapping. It can also be applied to any of the above-described four schemes to increase the control and accuracy of the multi-touch input.

In some examples, the parameters of the non-linear function can be made dependent on size of display device and/or the size of the touch detection portion of the indirect multi-touch interaction device. For example, a large display device gives rise to a large user interface, hence the acceleration parameters can be adapted such that the user is able to manipulate objects over a sufficient extent of the user interface. For example, the amount of acceleration can be increased, so that the distance traveled by a representation for a given digit velocity is larger for large displays.

Similarly, the size of the touch detection portion of the indirect multi-touch interaction device can be used to adapt the acceleration parameters. For example, a large touch detection portion means that less acceleration can be applied to the representations, as the user has a wider range of digit movement.

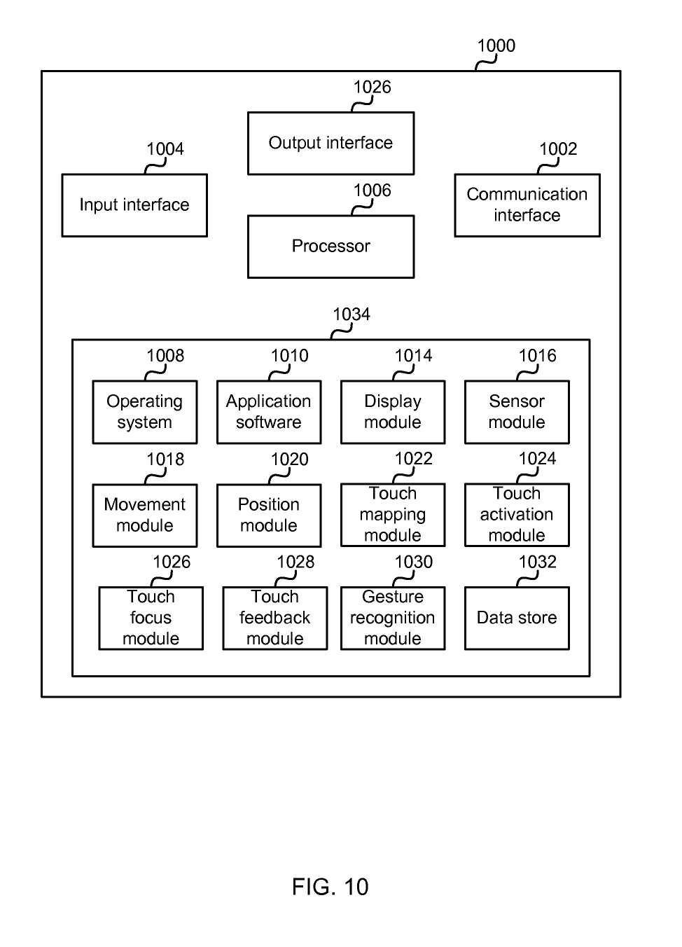

FIG. 10 illustrates various components of an exemplary computing-based device 1000 which can be implemented as any form of a computing and/or electronic device, and in which embodiments of the techniques for using the indirect multi-touch interaction described herein can be implemented.

The computing-based device 1000 comprises one or more input interfaces 1002 which are of any suitable type for receiving data from an indirect multi-touch interaction device and optionally one or more other input devices, such as a keyboard. An output interface 1004 is arranged to output display information to display device 604 which can be separate from or integral to the computing-based device 1000. The display information provides the graphical user interface. Optionally, a communication interface 1006 can be provided for data communication with one or more networks, such as the internet.

Computing-based device 1000 also comprises one or more processors 1008 which can be microprocessors, controllers or any other suitable type of processors for processing executable instructions to control the operation of the device in order to perform the techniques described herein. Platform software comprising an operating system 1010 or any other suitable platform software can be provided at the computing-based device to enable application software 1012 to be executed on the device. Other software functions can comprise one or more of:
A display module 1014 arranged to control the display device 800, including for example the display of the user interface;
A sensor module 1016 arranged to read data from the at least one indirect interaction device describing the sensed location and movement of one or more of the user's hands and digits;
A movement module 1018 arranged to determine the movement of one or more of the user's hands and digits from the sensed data;
A position module 1020 arranged to read sensor data and determine the position of one or more of the user's hands and digits from the sensed data;
A touch mapping module 1022 arranged to determine where in the user interface to map user touch-points;
A touch activation module 1024 arranged to determine when to activate multi-touch input from the indirect interaction device;
A touch focus module 1026 arranged to determine whether an object in the user interface is to receive the multi-touch input;
A touch feedback module 1028 arranged to display the multi-touch pointer;
A gesture recognition module 1030 arranged to analyze the position data and/or the movement data and detect user gestures; and
A data store 1032 arranged to store sensor data, images, analyzed data etc.

The computer executable instructions can be provided using any computer-readable media, such as memory 1034. The memory is of any suitable type such as random access memory (RAM), a disk storage device of any type such as a magnetic or optical storage device, a hard disk drive, or a CD, DVD or other disc drive. Flash memory, EPROM or EEPROM can also be used. Although the memory is shown within the computing-based device 1000 it will be appreciated that the storage may be distributed or located remotely and accessed via a network or other communication link (e.g. using communication interface 1006).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of manipulating an object displayed in a user interface on a display device, comprising:
receiving a first data sequence describing movement of a cursor control device operable by a user;
receiving a second data sequence describing movement of a plurality of digits of the user;
displaying in the user interface a cursor and a representation of at least one of the plurality of digits, and moving the cursor in the user interface in dependence on the first data sequence; and
determining from at least one parameter that multi-touch input is to be provided to the object, the parameter comprising the cursor location in the user interface, and, responsive thereto, analyzing the relative movement of the plurality of digits and manipulating the object in the user interface in dependence thereon.

2. A method according to claim 1, wherein the step of determining comprises determining that the cursor location is coincident with the location of at least a portion of the object in the user interface.

3. A method according to claim 1, wherein the method further comprises the step of receiving a third data sequence indicating an activation state of a user-operable control, and the at least one parameter further comprises the activation state from the third data sequence.

4. A method according to claim 3, wherein the step of determining further comprises detecting that the user-operable control is held in an activated state whilst the cursor location is coincident with the location of at least a portion of the object in the user interface.

5. A method according to claim 3, wherein the step of determining further comprises detecting that the user-operable control is changed to an activated state for at least a predefined time interval whilst the cursor location is coincident with the location of at least a portion of the object in the user interface.

6. A method according to claim 1, wherein the representation of at least one of the plurality of digits is displayed in proximity to a control point of the cursor.

7. A method according to claim 6, wherein the step of moving the cursor in the user interface in dependence on the first data sequence further comprises maintaining the location of the representation relative to the cursor.

8. A method according to claim 7, wherein the step of determining comprises determining that the cursor location is such that the representation location in the user interface is coincident with the location of at least a portion of the object in the user interface.

9. A method according to claim 1, wherein the cursor control device is a multi-touch mouse device arranged to sense movement of a base portion of the multi-touch mouse device over a supporting surface and sense movement of a plurality of digits of the user of the multi-touch mouse device relative to the base portion, and wherein the first data sequence describes the movement of the base portion, and the second data sequence describes movement of the digits of the user relative to the base portion.

10. A method according to claim 1, wherein the cursor control device is a mouse device, and the first data sequence describes the movement of the mouse device over a supporting surface.

11. A method according to claim 1, wherein the cursor control device is a touch pad, and the first data sequence describes the movement of a contact point of the user on the touch pad.

12. A method according to claim 1, wherein the cursor control device is an imaging device arranged to detect movement of a hand of the user.

13. A method according to claim 1, wherein the second data sequence is provided by a touch pad arranged to sense movement of a plurality of digits of the user over the touch pad.

14. A method according to claim 1, wherein the second data sequence is provided by an imaging device arranged to sense movement of a plurality of digits of the user.

15. A method according to claim 1, wherein the step of manipulating the object comprises at least one of: rotating the object; scaling the object; and translating the object.

16. A computer-implemented method of manipulating an object displayed in a user interface on a display device, comprising:
receiving a data sequence describing movement of a plurality of digits of the user;
displaying in the user interface a representation of each of the plurality of digits;
processing the data sequence such that movement of each digit by the user moves the corresponding representation in the user interface, and the movement velocity of the representation is a non-linear function of the movement velocity of the corresponding digit; and
determining that multi-touch input is to be provided to the object, and, responsive thereto, analyzing the relative movement of each representation and manipulating the object in the user interface in dependence thereon.

17. A method according to claim 16, wherein the non-linear function is an acceleration function arranged to cause the movement velocity of the representation to be proportionately larger for a first movement velocity of a digit than for a second, smaller movement velocity of a digit.

18. A method according to claim 16, wherein the non-linear function is dependent on size of display device.

19. A method according to claim 16, further comprising the steps of:
receiving a further data sequence describing movement of a cursor control device operable by a user; and
displaying in the user interface a cursor, and moving the cursor in the user interface in dependence on the further data sequence, and
wherein the step of determining that multi-touch input is to be provided to the object is based on the cursor location in the user interface.

20. A computer system, comprising:
a display device;
an input interface arranged to receive a first and second data sequence from a multi-touch mouse device operable by a user, the first data sequence describing movement of a base portion of the multi-touch mouse device, and the second data sequence describing movement of a plurality of digits of the user of the multi-touch mouse device relative to the base portion; and
a processor arranged to display a user interface comprising an object on the display device, display in the user interface a cursor and a representation of each of the plurality of digits, move the cursor in the user interface in dependence on the first data sequence, determine from at least one parameter that multi-touch input is to be provided to the object, the parameter comprising the cursor location in the user interface, and, responsive thereto, analyze the relative movement of the plurality of digits and manipulate the object in the user interface in dependence thereon.
